(19) United States
(12) Patent Application Publication
(10) Pub. No.: US 2016/0014972 A1
(43) Pub. Date: Jan. 21, 2016

(54) Ventilation System for Ventilating Particulate Materials Disposed in a Storage Bin

(71) Applicant: Gatco Manufacturing Inc., Saskatoon (CA)

(72) Inventor: Gary Schreiner, Saskatoon (CA)

(21) Appl. No.: 14/696,932

(22) Filed: Apr. 27, 2015

Related U.S. Application Data
(63) Continuation of application No. 12/657,634, filed on Jan. 25, 2010.

(51) Int. Cl. A01F 25/22

(52) U.S. Cl. CPC A01F 25/22

(57) ABSTRACT

A ventilation system for ventilating particulate materials disposed in a storage bin is provided. The ventilation system comprises an extendable elongated hollow body for being disposed in proximity of a center of the storage bin and oriented substantially vertical. The body comprises a plurality of body sections and when extended has a length approximately equal to a distance between a bottom portion of the storage bin and a top portion of the storage bin. The body has a plurality of apertures such that airflow between inside and outside the body is enabled while transmission of the particulate materials into the body is substantially prevented. A holding mechanism is mounted to the body and to at least one of the top portion and the bottom portion of the storage bin.

This application is a continuation application of application Ser. No. 12/657634 filed Jan. 25, 2010 and now issued to Patent ______.

The present invention relates to ventilation of particulate materials disposed in a storage bin, and more particularly to a ventilation system using naturally occurring convection.

### BACKGROUND OF THE INVENTION

After harvest grain such as, for example, wheat, rye, barley, canola, soybeans, is stored in storage bins—on site at a farm or in large commercial storage facilities—prior distribution for processing or sale. Typically, the grain is stored in the storage bins during fall and winter.

Temperature changes due to changing seasons result in an unequal temperature distribution within the grain stored inside the storage bin causing natural convection of air through the grain and causing moisture to migrate therewith. The moisture then gathers in the top portion of the stored grain causing it to spoil. Depending on the temperature and the moisture content of the grain spoilage occurs within weeks or even days.

To prevent spoilage of grain stored in storage bins grain aeration systems or grain drying systems are employed. In grain aeration systems a fan provides a flow of outside air into and through the stored grain. Unfortunately, aeration systems are relatively complex and expensive to manufacture, install, and operate. Furthermore, in conditions of high humidity of the outside air the aeration is ineffective in preventing spoilage of the grain. Grain drying systems are more effective in humid conditions of the outside air, but are even more expensive to operate than aeration systems and care must be taken that the stored grain is not damaged due to too high temperatures of the heated air provided by the grain drying system.

It is desirable to provide a ventilation system for ventilating particulate materials disposed in a storage bin that is simple and easy to install.

It is also desirable to provide a ventilation system for ventilating particulate materials disposed in a storage bin that uses naturally occurring convection.

### SUMMARY OF THE INVENTION

Accordingly, one object of the present invention is to provide a ventilation system for ventilating particulate materials disposed in a storage bin that is simple and easy to install.

Another object of the present invention is to provide a ventilation system for ventilating particulate materials disposed in a storage bin that may use naturally occurring convection.

According to one-aspect of the present invention, there is provided a ventilation system for ventilating particulate materials disposed in a storage bin. The ventilation system comprises an extendable elongated hollow body for being disposed in proximity of a center of the storage bin and oriented substantially vertical. The body comprises a plurality of body sections and when extended has a length approximately equal to a distance between a bottom portion of the storage bin and a top portion of the storage bin. The body has a plurality of apertures such that airflow between inside and outside the body is enabled while transmission of the particulate materials into the body is substantially prevented. A holding mechanism is mounted to the body and to at least one of the top portion and the bottom portion of the storage bin.

According to another aspect of the present invention, there is provided a ventilation system for ventilating particulate materials disposed in a storage bin. The ventilation system comprises an extendable elongated hollow body for being disposed in proximity of a center of the storage bin and oriented substantially vertical. The body comprises a plurality of telescopic body sections and when extended has a length approximately equal to a distance between a bottom portion of the storage bin and a top portion of the storage bin. The body has a plurality of apertures such that airflow between inside and outside the body is enabled while transmission of the particulate materials into the body is substantially prevented. A holding mechanism is mounted to the body and to at least one of the top portion and the bottom portion of the storage bin.

The advantage of the present invention is that it provides a ventilation system for ventilating particulate materials disposed in a storage bin that is simple and easy to install.

A further advantage of the present invention is that it provides a ventilation system for ventilating particulate materials disposed in a storage bin that uses naturally occurring convection.

### BRIEF DESCRIPTION OF THE DRAWINGS

A preferred embodiment of the present invention is described below with reference to the accompanying drawings, in which:

FIGS. 1a and 1b are simplified block diagrams illustrating in cross sectional views of a storage bin natural convection occurring within grain stored therein without and with a ventilation system according to a preferred embodiment of the invention;

FIG. 2a is a simplified block diagram illustrating a side view of the ventilation system according to a preferred embodiment of the invention;

FIG. 2a is a simplified block diagram illustrating a cross sectional view of the ventilation system according to a preferred embodiment of the invention installed in a storage bin;

FIG. 2b is a simplified block diagram illustrating a side view of a portion of the body of the ventilation system according to a preferred embodiment of the invention;

FIGS. 3a and 3b are simplified block diagrams illustrating a bottom holding mechanism for mounting the ventilation system according to a preferred embodiment of the invention to the bottom of the storage bin;

FIGS. 3c and 3d are simplified block diagrams illustrating a top holding mechanism for mounting the ventilation system according to a preferred embodiment of the invention to the top of the storage bin;

FIG. 3e is a cross-sectional view of an embodiment of a bottom holding mechanism having a rare earth magnet therein;

FIG. 3f is an upper element of a free standing base;

FIG. 3g is a view of the upper element of the free standing base of FIG. 3f attached to a lower element of the free standing base;

FIG. 3h is a perspective view of a connector for attaching one or more extension pipes to the lower end of the body of the ventilation device in one embodiment of the present invention;

FIGS. 4a to 4c are simplified block diagrams illustrating a telescopic extendable body of the ventilation system according to a preferred embodiment of the invention;

FIGS. 4d and 4e are simplified block diagrams illustrating an alternative embodiment of a telescopic extendable body of the ventilation system according to embodiments of the invention; and,

FIGS. 5a to 5d are simplified block diagrams illustrating various connecting mechanisms for connecting a plurality of body sections of the ventilation system according to embodiments of the invention.

### DETAILED DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While the description of the preferred embodiments herein below is with reference to a ventilation system for ventilating grain disposed in a storage bin, it will become evident to those skilled in the art that the embodiments of the invention are not limited thereto, but are also applicable for ventilating numerous other stored particulate materials where a reduction in moisture content and/or a substantially equal temperature distribution within the stored particulate materials is desirable.

Furthermore, while the description of the preferred embodiments herein below is with reference to a ventilation system for ventilating grain disposed in a storage bin having a circular cross section, it will become evident to those skilled in the art that the embodiments of the invention are not limited thereto, but are also applicable for storage bins having other cross sections such as, for example, cross sections of square or rectangular shape.

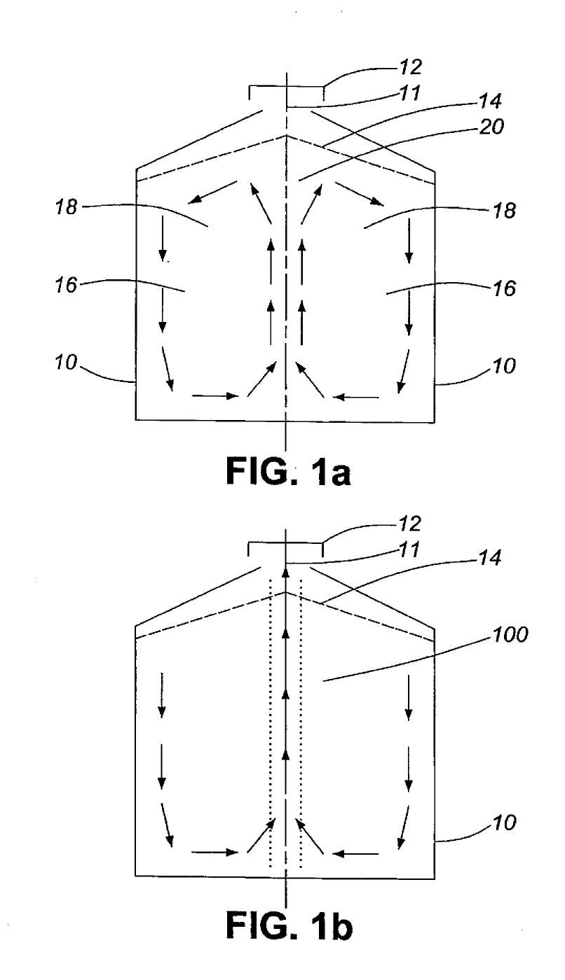

Referring to FIGS. 1a and 1b, a cross sectional view through a filled state of the art grain storage bin 10 is shown, illustrating natural convection occurring therein during fall and winter without a ventilation system and with a ventilation system according to embodiments of the invention, respectively. Grain is disposed within the storage bin 10 to a fill level 14. Cooler temperatures during fall and winter cause an unequal temperature distribution within the stored grain with zones of lower temperature 16 located in proximity to the outside walls of the storage bin 10 and zones of higher temperature 18 located in proximity to the center of the storage bin 10. The unequal temperature distribution causes a natural convection to occur inside the stored grain as indicated by the arrows. Without a ventilation system, as illustrated in FIG. 1a, the natural convection causes a substantially closed circuit of airflow within the stored grain and warm moist air is transported in proximity to the center of the storage bin 10 to the top of the stored grain. Due to cooler temperatures in the top portion 20 of the stored grain the moisture condenses and gathers therein. With the ventilation system 100 according to embodiments of the invention, as illustrated in FIG. 1b, the closed circuit of natural convection is interrupted and the warm moist air is guided to the outside through the ventilation system 100 and opening 11 between the top portion of the storage bin 10 and lid 12 as indicated by the arrows. Thus, the moisture is guided to the outside and prevented from gathering. Furthermore, guiding the warm air to the outside equalizes the temperatures between the zones of warmer temperatures and cooler temperatures in the stored grain.

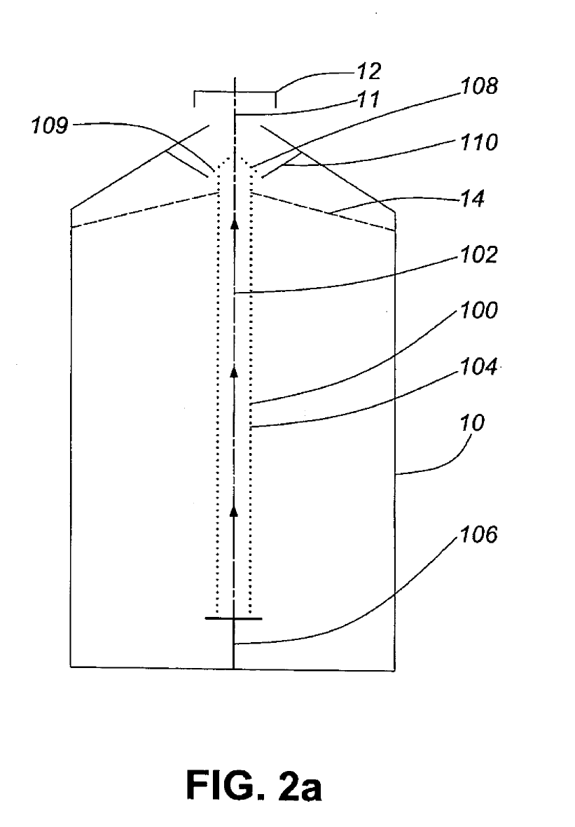

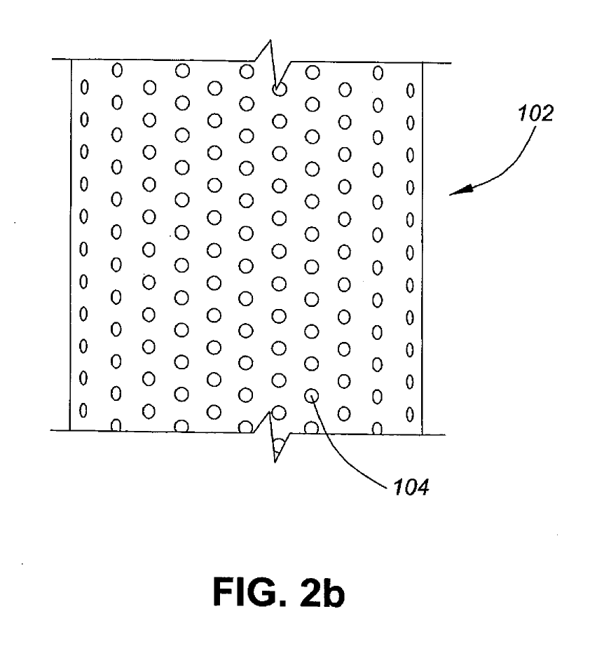

Referring to FIGS. 2a and 2b, a ventilation system 100 for ventilating grain disposed in a storage bin according to a preferred embodiment of the invention is provided. The ventilation system comprises an extendable elongated hollow body 102, a holding mechanism 106, 110 mounted to the body 102, and a cap 108. The ventilation system 100 is disposed in proximity of a center of the storage bin 10 and oriented substantially vertical. The body 102 comprises a plurality of body sections, as will be described herein below, and when extended has a length approximately equal to a distance between a bottom portion of the storage bin and a top portion of the storage bin 10 such that a top portion of the ventilation system 100 is disposed above the fill level 14 and in proximity to the opening 11. The body 102 has a plurality of apertures 104 such that airflow between inside and outside the body 102 is enabled while transmission of the grain into the body 102 is substantially prevented.

Preferably, the body 102 has a circular cross section, but is not-limited thereto, and various other shapes are also employable such as, for example, square, rectangular, triangular, or ellipsoidal. The size of the cross section is determined, for example, in dependence upon a predetermined airflow to be enabled by the ventilation system 100 for ventilating the stored grain.

Preferably, the apertures 104 are of circular shape, as illustrated in FIG. 2b, but are not limited thereto, and various other shapes are also employable such as, for example, square, rectangular, triangular, ellipsoidal, or combinations thereof. Size and distribution of the apertures are determined, for example, in dependence upon the size of the grain, a predetermined airflow to be enabled by the ventilation system 100 for ventilating the stored grain. Further preferably, the apertures 104 are equally distributed, as illustrated in FIG. 2b. Optionally, the apertures 104 are distributed in an unequal fashion, for example, providing more apertures 104 on a middle portion of the body 102—which is likely disposed in proximity to a warmer zone of the stored grain than a top and bottom portion of the body 102—and less or no apertures 104 on the top and bottom portion of the body 102.

Preferably, the body sections are made using standard technology such as, for example, forming metal tubing from sheet metal, for example, galvanized steel or aluminum' having the apertures 104 cut therein using laser cutting technology or a punch press. Alternatively, other manufacturing technologies and materials are employed such as, for example, plastic molding techniques. Further alternatively, a rigid body structure, for example, made of rods and rings outlining the shape of each of the body sections, is surrounded with an appropriate wire mesh.

Preferably, the top of the body 102 is covered for preventing disposal of grain inside the body 102 when filled into the storage bin 10 through opening 11 by providing a cap 108 mounted to a top portion of the body 102. The cap 108 is shaped—for example, forming a pyramid, a cone, or a half sphere—for dispersing the grain into the storage bin 10 when impinging thereupon.

Further preferably, the cap 108 comprises a plurality of apertures 109 such that airflow between inside and outside the body 102 is enabled while transmission of the particulate materials into the body 102 is substantially prevented. The apertures 109 are, for example, of same shape and size as the apertures 104. Optionally, the apertures 109 are of different shape and/or size depending, for example, on the orientation of a cap surface with respect to the impinging grain. Further optionally, the apertures 109 are omitted and the airflow is guided to the outside, for example, through the apertures 104 disposed in the top portion of the body 102, or a predetermined gap between the body 102 and the cap 108.

Preferably, the holding mechanism comprises a bottom holding mechanism 106 mounted to a bottom portion of the body 102 for being mounted to a bottom structure of the storage bin 10 and a top holding mechanism 110 for being mounted to a top structure of the storage bin 10, as illustrated in FIG. 2a.

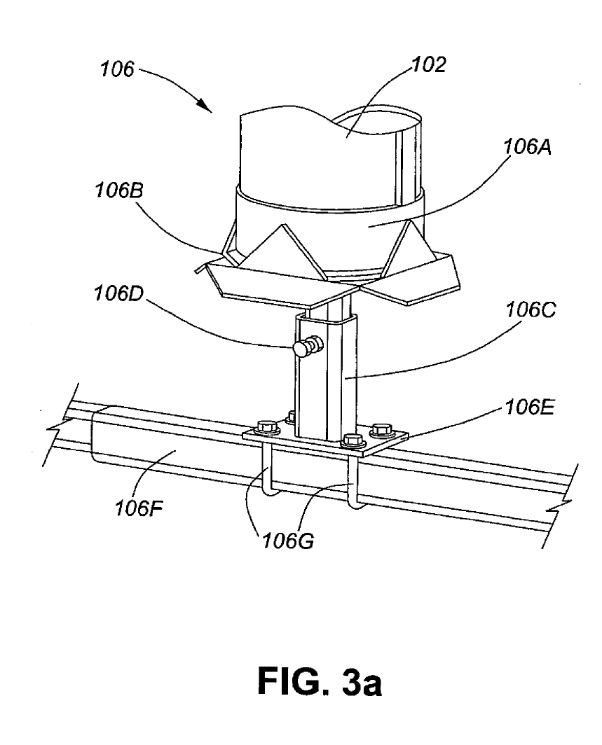

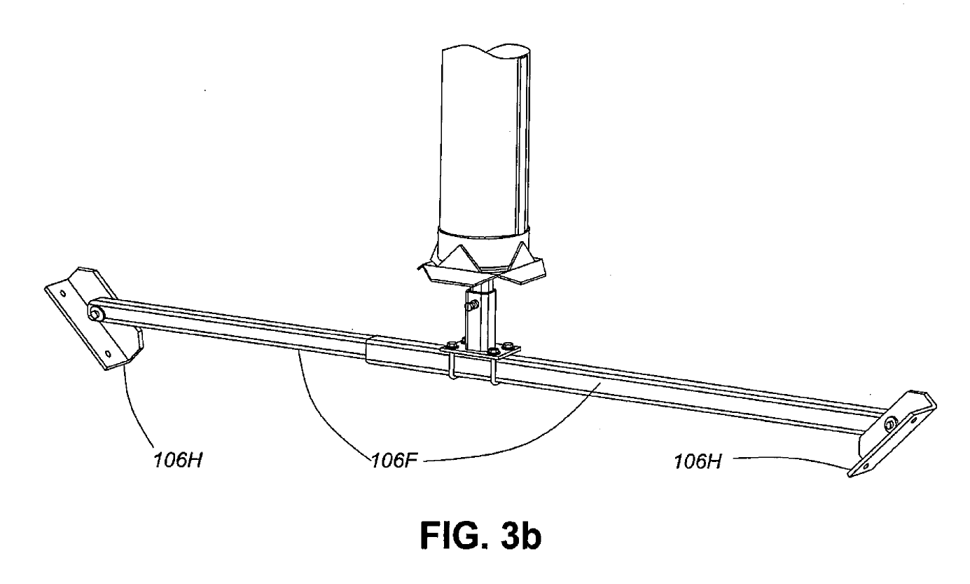

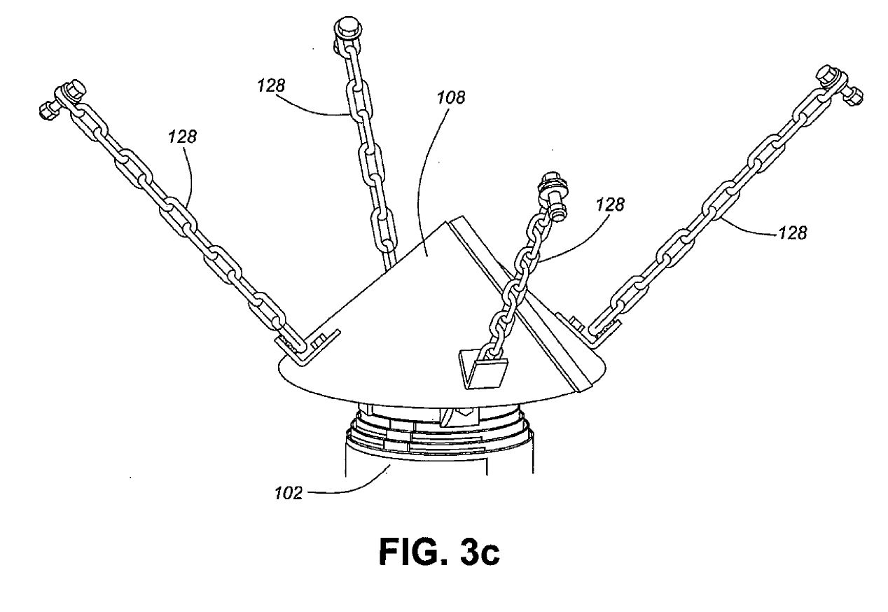

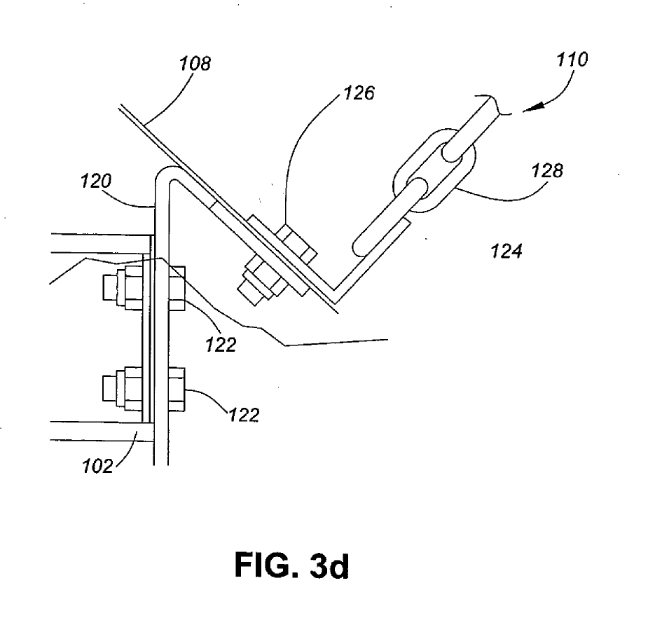

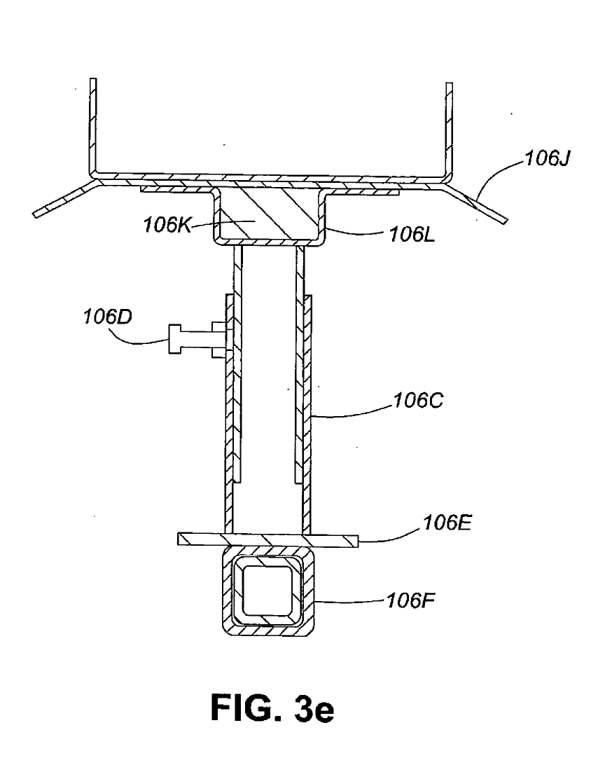

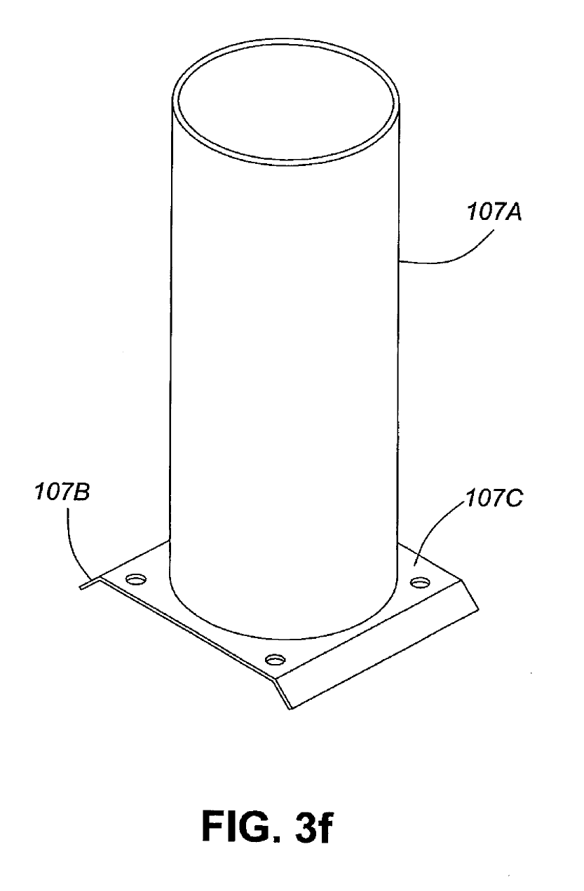

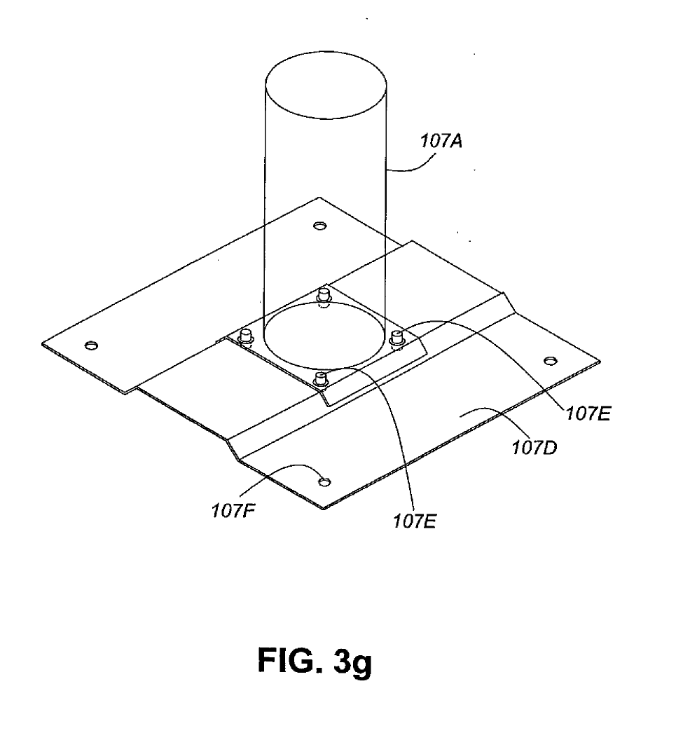

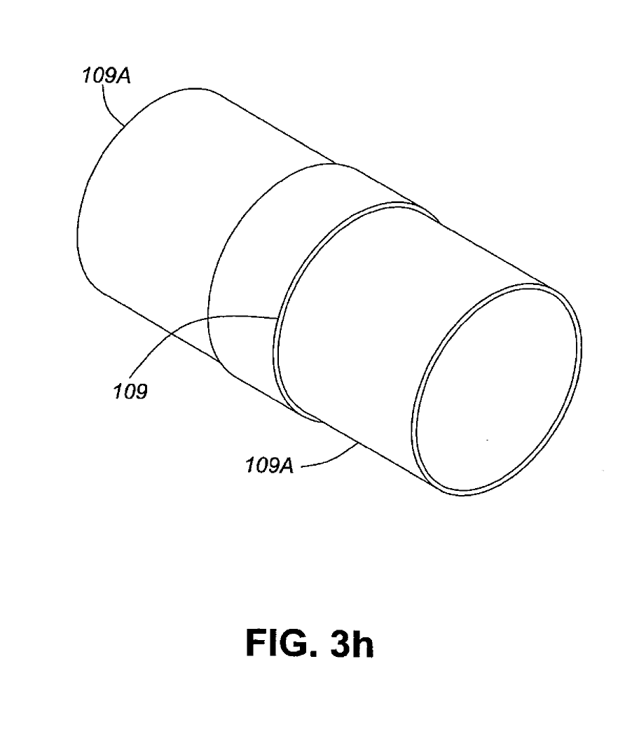

Referring to FIGS. 3a and 3b, a preferred embodiment of a bottom holding mechanism 106 is provided. The bottom holding mechanism 106 comprises a base 106B having a flange or a collar 106A mounted thereupon snugly accommodating the bottom portion of the body 102 therein, as illustrated in FIG. 3a. The base 106B is mounted to a telescopic extendable support 106C which allows a vertical adjustment of the body 102 using screw mechanism 106D with the consequence that the bottom holding mechanism is arranged to extend downwardly from the bottom end to the bottom floor of the storage bin and is extendible and retractable relative to the bottom floor of the storage bin.

Support base 106E of the extendable support 106C is mounted to extendable beam structure 106F using, for example, U-shaped mounting mechanisms 106G. The extendable beam structure 106F has end portions 106H mounted thereto for interfacing with a sloped wall portion of a hopper. Thus the bottom holding mechanism comprises a transverse beam structure extending outwardly from sides of the bottom portion of the elongate hollow body to a wall of the storage bin. Preferably, each of the end portions 10611 comprises a flat surface having a substantially same slope as a sloped wall portion of the hopper, which is screwed, welded or otherwise securely fastened to the sloped wall portion.

Alternatively, the end portions are hold in place by friction using, for example, a rubber layer disposed between the flat surface and the sloped wall portion. Optionally, the beam structure comprises more than two end portions. Further alternatively, the bottom portion of the body 102 is mounted to the base 106B using, for example, angle fittings.

Optionally, the support base 106E is, for example, directly mounted to the floor structure of the storage bin 10 using screws, bolts, welding or other secure fastenment means.

In the embodiment of the bottom holding mechanism of FIG. 3e, a rare earth magnet 106K is positioned within a cavity 106L in the bottom holding mechanism, the rare earth magnet 106K being adapted to directly or indirectly magnetically engage with the walls and/or bottom of the cavity and being adapted to directly or indirectly magnetically engage with the lower end of the steel body 102 in a manner known to a person skilled in the art with the consequential result that that the bottom holding mechanism at the bottom end of the elongated hollow body is arranged such that the bottom end of the elongate hollow body is releasable from the bottom holding mechanism.

While the bottom holding mechanism of FIGS. 3a and 3b may be readily used in hopper or “V” bottom type bins, in one embodiment of the present invention, in place of the bottom holding mechanism of FIGS. 3a and 3b, a free standing base as illustrated in FIGS. 3f and 3g may be used in flat bottom bins and the like, the lower element of the free standing base 107D being positioned or securely fastened to the bottom or floor of the flat bottom bin (by way of, for example, bolts passing through holes 107F in the lower element of the free standing base 107D and into the bottom or floor of the flat bottom bin, or by other fastenment means known to a person skilled in the art), the upper element of the free standing base (having a tubular element 107A welded or otherwise securely fastened to a base element 107B, the upper element of the free standing base being for example bolted 107E through holes 107C, welded or otherwise securely fastened to the lower element of the free standing base illustrated in FIG. 3f) extending in a generally vertical orientation, and being adapted for engagement with the bottom of the lower end of the steel body 102 in a manner known to a person skilled in the art, and preferably by positioning the upper element of the free standing base 107A within, and in snug engagement with the inside surface of the hollow lower end of the steel body 102 in a known manner, it being understood that alternative methods for such attachment are known to a person skilled in the art.

With reference to FIG. 3h a connector 109 is provided, which may, for example, be inserted into the lower portion of the body to couple the body to an extension pipe (not shown), the connector ends 109A being of reduced diameter relative to the inside diameter of the body and extension pipe (not shown), the connector ends 109A being snugly insertable into the interior of the lower portion of the body and into the interior of the extension pipe (not shown), the connector ends 109A coupling the body to the extension pipe to thereby extend the body as needed or desired.

Referring to FIGS. 3c and 3d, a preferred embodiment of a top holding mechanism 110 is provided. The cap 108 is mounted to the top portion of the body 102 using at least two angle fittings 120 mounted to top portion of the body 102 via screws 122 and screw 126. In FIG. 3d only one angle fitting is shown for simplicity. Chain 128 is mounted to the angle fitting 120 via angle fitting 124 and screw 126. At least two chains 128 are then mounted to the top portion of the storage bin 10, for example, to a ring structure surrounding opening 11. For example, the top holding mechanism 110, as illustrated in FIGS. 3c and 3d, enables hanging of the ventilation system 100 from the top portion of the storage bin 10 during installation. Alternatively, the chains 128 are mounted to a ring structure surrounding the top portion of the body 102.

Preferably, the body 102 comprises a plurality of body sections which are mounted together during installation inside the storage bin 10 or telescoping body sections enabling telescopic extension of the body 102 during installation inside the storage bin for providing a body 102 having a length approximately equal to a distance between a bottom portion of the storage bin 10 and a top portion of the storage bin 10. Providing an extendable body 102 substantially facilitates installation of the ventilation system 100 inside the storage bin 10, for example, when installed as a retrofit. The length of the body sections is determined such that handling of the same is facilitated—for example, during transport by having a length that easily fits on a truck, as well as during installation by having a length that allows provision of the ventilation system 100 into the storage bin through a manhole in the bottom portion of the storage bin, thus obviating the use of a crane for lifting the ventilation system 100 through the opening 11 in the top of the storage bin 10.

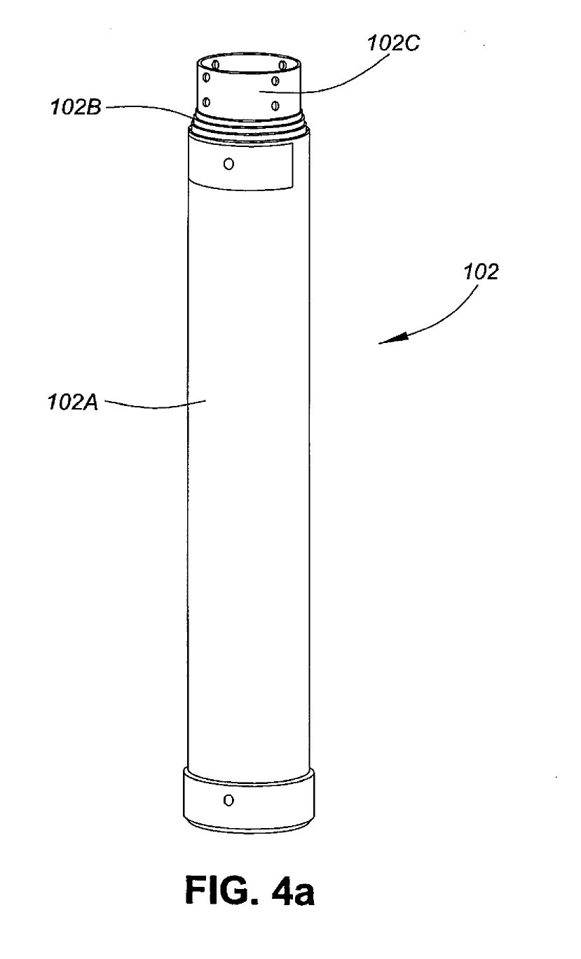

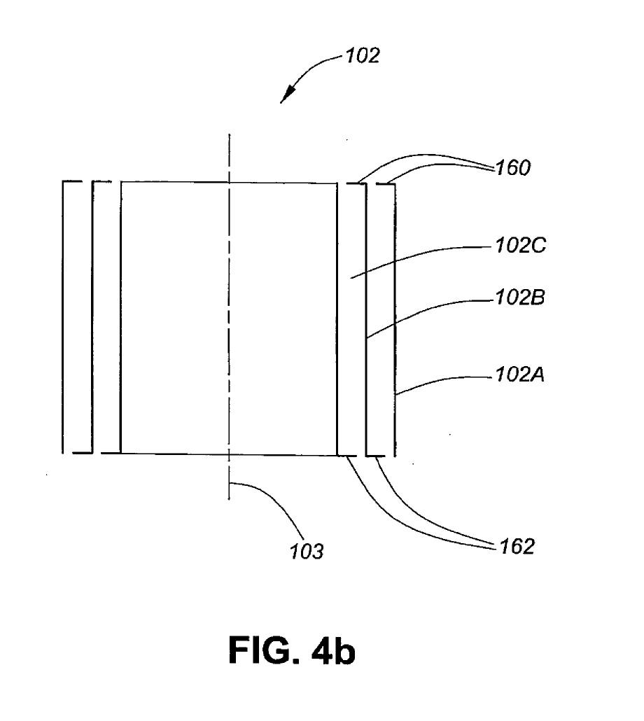

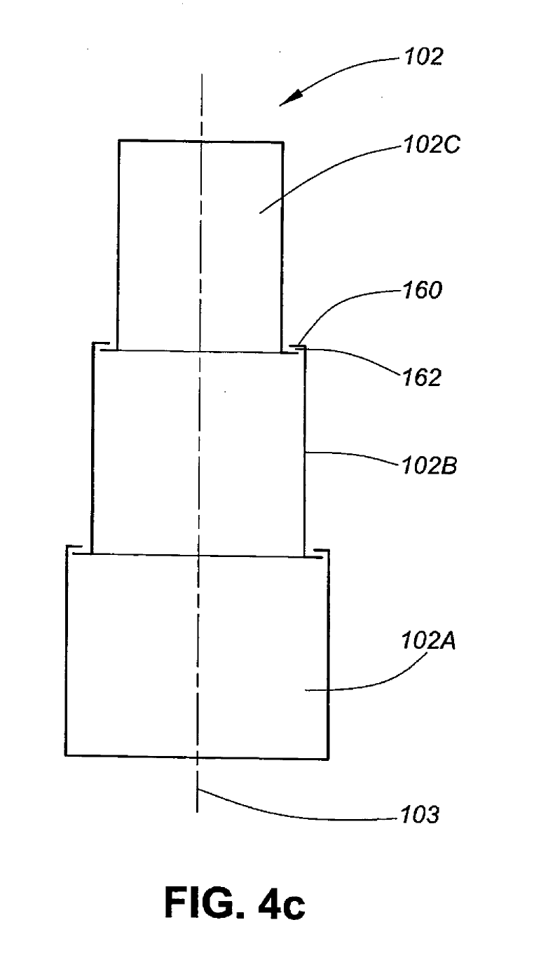

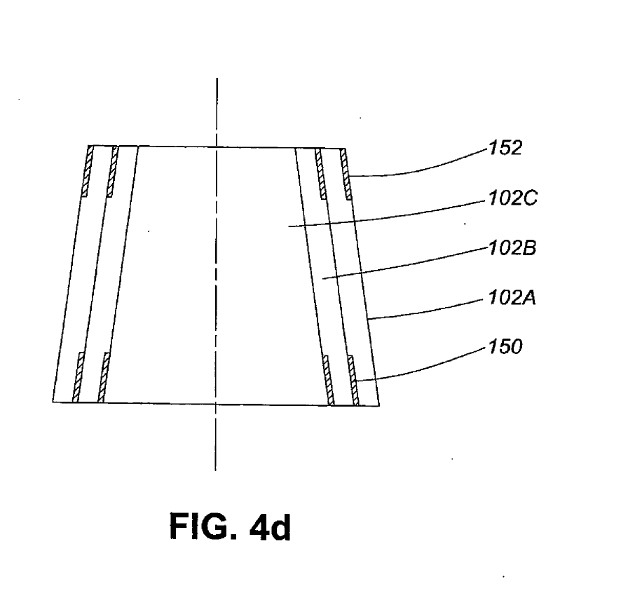

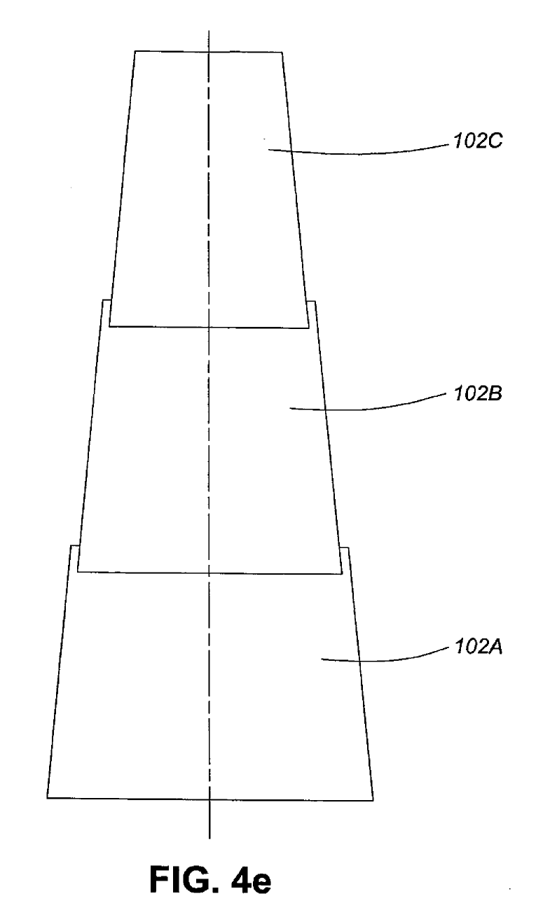

Referring to FIGS. 4a to 4c, a preferred embodiment of a telescopic extendable body 102 of a ventilation system according to the invention is shown. The telescopic extendable body 102 comprises a plurality of telescoping body sections 102A, 1028, 102C. Each telescoping body section 102A, 102B, 102C has a constant cross section along longitudinal axis 103. The cross sections are varied such that a successive body section is accommodated inside a previous body section. Preferably, the size of the cross sections of successive body sections 102A, 102B, 102C is decreasing from the bottom body section 102A to the top body section 102C. Prior installation, the top body section 102C is accommodated inside the body section 102B which itself is accommodated inside the bottom body section 102A, as illustrated in FIGS. 4a and 4b. During installation the top body section 102C is, for example, pulled towards the top of the storage bin 10 for extending the body 102, as illustrated in FIG. 4c. End portions of the telescoping body sections 102A, 102B, 102C are provided with respective stop mechanisms 160, 162—for example, inside and outside stop rings—mounted to the inside and outside of the respective body sections 102A, 102B, 102C as illustrated in FIG. 4b. When the body 102 is extended, inside stop ring 162 abuts outside stop ring 160, as illustrated in FIG. 4c. As is evident, the preferred embodiment is not limited to three body sections as illustrated in FIGS. 4b and 4c, but various other numbers of body sections—two, four or more—are also applicable.

Alternatively, as illustrated in FIGS. 4d and 4e, the telescoping body sections 102A, 102B, 102C are tapered such that when the body 102 is extended an end portion outside surface 150 of the second body section 102B interacts with an end portion inside surface 152 of the first body section 102A providing, for example, a snugly fit.

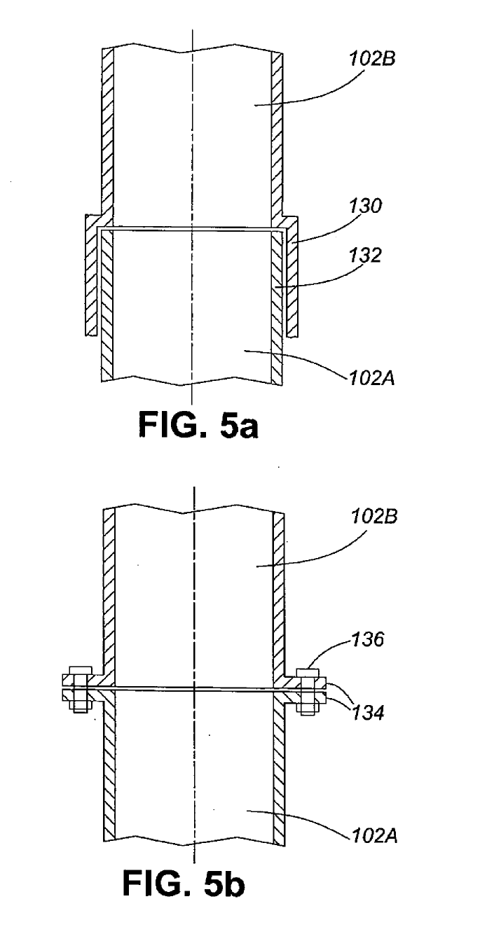

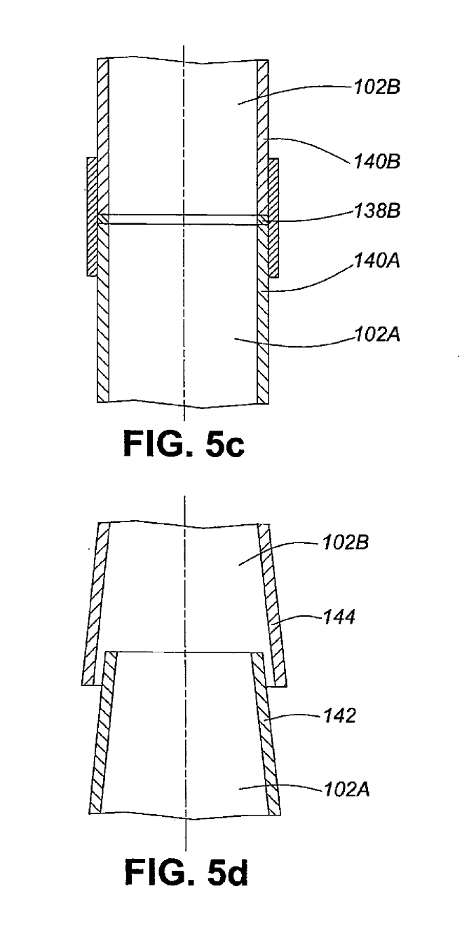

Further alternatively, separate body sections 102A, 102B, are mated during installation inside the storage bin 10. Referring to FIGS. 5a to 5d, various embodiments of a mechanism for mating a plurality of body sections 102A, 102B are shown. As illustrated in FIG. 5a, an end portion of second body section 102B is shaped for being mated with a corresponding end portion of a first body section 102A. The second body section 102B comprises a flange 130 for accommodating the corresponding end portion 132 of the first body section 102A using, for example, a snugly fit. Alternatively, the body sections 102A and 102B comprise respective flanges 134 which are mounted together using screws 136, as illustrated in FIG. 5b. Further alternatively, connecting element 138 is interposed between the body sections 102A and 102B, as illustrated in FIG. 5c. The connecting element 138 accommodates respective end portions 140A and 140B of body section 102A and 102B using, for example, a snugly fit. Further alternatively, each body section 102A, 102B is tapered such that an end portion outside surface 142 of a first body section 102A interacts with an end portion inside surface 144 of a second body section 102B providing, for example, a snugly fit, as illustrated in FIG. 5d. Optionally, the body 102 is tapered—for example, having a smaller cross section at the top than at the bottom—and the end portions are shaped for mating corresponding body sections of a predetermined sequence of body sections forming the tapered body 102.

The present invention has been described herein with regard to preferred embodiments. However, it will be obvious to persons skilled in the art that a number of variations and modifications can be made without departing from the scope of the invention as described herein.

1. A ventilation system for ventilating particulate materials disposed in a storage bin comprising:
an elongated hollow body for being disposed in proximity of a center of the storage bin and oriented substantially vertical;
the elongated hollow body having a length between a top end and a bottom end equal to a distance between a bottom portion of the storage bin and a location below a top opening of the storage bin,
the elongated hollow body having a plurality of apertures arranged such that airflow into the elongated hollow body from the particulate material in the storage bin is enabled while transmission of the particulate materials into the elongated hollow body is substantially prevented;
a venting arrangement for venting the airflow from inside the elongated hollow body such that the airflow can be discharged to an exterior of the storage bin; and,
a support mechanism adapted for supporting the elongated hollow body, during use of the ventilation system, in a suspended position of the elongated hollow body such that the top end of the elongated hollow body is spaced below the top opening of the storage bin and the bottom end of the elongated hollow body is spaced from a bottom of the storage bin;
and a bottom holding mechanism connected to a bottom portion of the elongated hollow body;
wherein the bottom holding mechanism comprises a transverse beam structure extending outwardly from sides of the bottom portion of the elongate hollow body to a wall of the storage bin.

2. A ventilation system for ventilating particulate materials disposed in a storage bin as defined in claim 1 wherein the transverse beam structure has end portions for interfacing with a sloped wall portion of a hopper bottom of the storage bin.

3. A ventilation system for ventilating particulate materials disposed in a storage bin as defined in claim 1 wherein the bottom holding mechanism is arranged such that the bottom end of the elongate hollow body is releasable from the bottom holding mechanism.

4. A ventilation system for ventilating particulate materials disposed in a storage bin as defined in claim 3 wherein the bottom holding mechanism includes a magnet by which the bottom end of the elongate hollow body is releasable.

5. A combination comprising a storage bin for particulate materials comprising:
a bin wall;
a bin bottom;
a bin roof defining a top portion of the bin with a top opening;
and a ventilation system for ventilating the particulate materials disposed in the storage bin as defined in claim 1.

6. A ventilation system for ventilating particulate materials disposed in a storage bin comprising:
an elongated hollow body for being disposed in proximity of a center of the storage bin and oriented substantially vertical;
the elongated hollow body having a length between a top end and a bottom end equal to a distance between a bottom floor of the storage bin and a location below a top opening of the storage bin,
the elongated hollow body having a plurality of apertures arranged such that airflow into the elongated hollow body from the particulate material in the storage bin is enabled while transmission of the particulate materials into the elongated hollow body is substantially prevented;
a venting arrangement for venting the airflow from inside the elongated hollow body such that the airflow can be discharged to an exterior of the storage bin; and,
a support mechanism adapted for supporting the elongated hollow body, during use of the ventilation system, in a suspended position of the elongated hollow body such that the top end of the elongated hollow body is spaced below the top opening of the storage bin and the bottom end of the elongated hollow body is spaced from a bottom of the storage bin;
and a bottom holding mechanism connected to the bottom end of the elongated hollow body;
wherein the bottom holding mechanism is arranged to extend downwardly from the bottom end to the bottom floor of the storage bin and is extendible and retractable relative to the bottom floor of the storage bin.

7. A combination comprising a storage bin for particulate materials comprising:
a bin wall;
a bin bottom;
a bin roof defining a top portion of the bin with a top opening;
and a ventilation system for ventilating the particulate materials disposed in the storage bin as defined in claim 6.

8. A ventilation system for ventilating particulate materials disposed in a storage bin comprising:
an elongated hollow body for being disposed in proximity of a center of the storage bin and oriented substantially vertical, the elongated hollow body having a length equal to a distance between a bottom floor of the storage bin and a location below a top opening of the storage bin,
the elongated hollow body having a plurality of apertures such that airflow into the elongated hollow body is enabled while transmission of the particulate materials into the elongated hollow body is substantially prevented;
a venting arrangement for venting the airflow from inside the elongated hollow body; and,
a support mechanism adapted for holding the elongated hollow body, during use of the ventilation system, in a suspended position of the elongated hollow body such that a bottom end of the elongated hollow body is spaced from a bottom of the storage bin;
and a bottom holding mechanism at the bottom end of the elongated hollow body;
the bottom holding mechanism being arranged such that the bottom end of the elongate hollow body is releasable from the bottom holding mechanism.

9. A ventilation system for ventilating particulate materials disposed in a storage bin as defined in claim 8 wherein the bottom holding mechanism includes a magnet by which the bottom end of the elongate hollow body is releasable.

10. A combination comprising a storage bin for particulate materials comprising:
a bin wall;
a bin bottom;
a bin roof defining a top portion of the bin with a top opening;
and a ventilation system for ventilating the particulate materials disposed in the storage bin as defined in claim 8.
